(19) United States
(12) Patent Application Publication
(10) Pub. No.: US 2017/0140384 A1
(43) Pub. Date: May 18, 2017

(54) EVENT SEQUENCE PROBABILITY ENHANCEMENT OF STREAMING FRAUD ANALYTICS

(71) Applicant: FAIR ISAAC CORPORATION, San Jose, CA (US)

(72) Inventors: Scott Michael Zoldi, San Diego, CA (US); David Frank Marver, Carlsbad, CA (US); Douglas Clare, San Diego, CA (US)

(21) Appl. No.: 14/940,110

(22) Filed: Nov. 12, 2015

(51) Int. Cl. G06Q 20/40; G06Q 40/00

(52) U.S. Cl. CPC G06Q 20/4016; G06Q 40/12

(57) ABSTRACT

A system and method is disclosed as using archetype-based n-grams based on an event sequence of the real-time transactions, the n-grams providing a probability based on a specific sequence of behavioral events and their likelihood, and in which high probability n-grams represent typical behaviors of customers in a same peer group, and low probability n-grams represent rare event sequences and increased risk.

### TECHNICAL FIELD

The subject matter described herein relates to fraud analytics, and more particularly to event sequence enhancement of streaming fraud analytics.

### BACKGROUND

Fraud continues to be a major concern of financial institutions and their customers, especially with respect to the use of credit cards, debit cards, online banking, mobile banking, and other retail banking products. State-of-the-art analytics applied to transaction streams associated with these products utilize behavioral streaming analytics, where a transaction profile is maintained for the customer, account, payment instrument, and channel to determine which transactions are consistent (or inconsistent) with the behavior of the legitimate customer. FICO's Falcon Fraud manager is one of the industry's most successful examples of these applied analytics, where highly refined models focus on entity-specific behavioral anomalies in the transaction stream to allow approve/decline decisions to be made in tens of milliseconds based on the probability of fraud associated with the transaction.

These analytics focus strongly on the past behaviors of customers drawn from recent transaction history. The anticipated future behavior of the customer is discerned from the behavioral patterns recognized within this history, and from which a model's fraud features are drawn. When models are trained, these behavioral fraud features are then weighted to form a final score that represents a probability of fraud. In a typical example, the score ranges from 1 to 999, where 999 is the highest probability of fraud and 1 is the lowest.

Although these analytics have proven highly successful, additional analytic value may be derived through additional analyses, and conventional behavioral streaming analytic models can be further enhanced with the evaluation of population-based behaviors leveraging customer archetypes. For example, when presented with a transaction(s) indicative of vacation travel for a customer for whom vacation travel transactions have not been seen in the past, it can be asked what a typical customer is likely to do when on vacation in a tourist location. What types of transactions or locations are highly probable or highly improbable for the customer based on others like him or her?

The ability to soft cluster customer's based on their transaction history and then utilize these clusterings to determine the historical risk of sequence events in the context of that soft clustering can be used to generate an independent fraud score. This independent fraud score equates to the probability of fraud based on transactions within subgroups of customers, devices, or channels. For example, this transaction sequence fraud score would treat a series of purchases associated with a business person and a college student very differently based on the archetypes that both belong as the risk levels for sequences of transactions in these clusters would be different. This score can be stand-alone providing a fraud probability of transaction sequence or can be incorporated into behavioral analytic transaction profiling fraud systems such as FICO's Falcon.

Regardless of the behaviors captured in a specific customer profile, understanding typical behavior in similar populations engaged in similar activities can add value in understanding the likelihood of any given transaction sequence. For instance, certain customers are more likely to shop at two or three stores within an event window on a Saturday morning than, say, on a Thursday evening. Transactions for certain brick-and-mortar retail merchants, such as dry cleaning and groceries, are more typically co-located in an event window than, say, theater tickets and appliances. For certain classes of customers, card-not-present transactions indicative of on-line shopping may also be highly correlated within a given event window. Certain consumers will bundle their on-line shopping tasks, just as they would visit multiple stores in a single trip to the mall.

Accordingly, by including features indicating the probability of an event based on the prior behavior of similar customers, such an enhancement would be particularly useful for new types of transactions not seen in the behavioral transaction pattern of a given customer.

### SUMMARY

This document presents systems and methods for streaming fraud analytics using n-grams based on event sequence. The systems and methods can be stand-alone n-gram-based fraud analytics, or can be used to enhance conventional fraud models employed in computer-implemented fraud detection systems, such as FICO's Falcon Fraud Manager, which utilize real-time transaction profiles with recursive fraud features to derive fraud likelihood. These models leverage features of past transaction behavior of a customer to determine normality or abnormality when trained across all customers and their associated transaction profiles.

The use of n-grams based on event sequence provides a set of features based on a specific sequence of events and their likelihood. Combined with archetype-based n-grams of events, high in probability n-grams point to typical behaviors of customers in the same peer groups, whereas low probabilities indicate rare event sequences that can point to increased risk.

In one aspect, a method, as well as a system executing the method, includes the steps of receiving transaction data of a structured, ordered sequence of transaction events. The transaction data of each transaction event includes a concatenated string composed of one or more transaction characteristics. The method further includes the step of generating one or more transaction event vectors from the transaction data, each of the one or more transaction event vectors representing a unique temporal trait associated with the one or more transaction characteristics. The method further includes the step of generating a soft clustering of customer, account, device, or channel based on archetypes derived from a transaction history associated with the customer, account, device, or channel.

The method further includes the step of generating an n-gram for the structured, ordered sequence of transaction events within each of the one or more transaction event vectors, where each n-gram represents an historical occurrence of each transaction event within an associated transaction event vector. The method further includes the step of generating a probability of an occurrence of a transaction event based on the n-gram within the associated transaction event vector and associated with the soft clustering of the customer, account, device, or channel. Finally, the method includes the step of generating a score for the transaction event, the score representing the probability of the occurrence of the transaction event in the context of the associated soft clustering of the customer, account, device, or channel.

Implementations of the current subject matter can include, but are not limited to, systems and methods consistent with one or more features described herein, as well as articles that comprise a tangibly embodied machine-readable medium operable to cause one or more machines (e.g., processors, computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates creation of n-gram “words” on a sequence of transactions for one customer.

FIG. 2 illustrates an example tabulation of n-grams.

FIG. 3 shows a sample construction of transaction event structures.

FIG. 4 shows a sample set of n-grams that can be generated from one specific transaction event vector.

FIG. 5 illustrates an exemplary n-gram generation from a transaction event vector.

FIG. 6 shows exemplary archetype distributions for difference payment.

FIG. 7 illustrates an architecture for an archetype-driven n-gram probability enhanced fraud detection model.

FIG. 8 is a flowchart illustrating a method in accordance with implementations described herein.

When practical, similar reference numbers denote similar structures, features, or elements.

### DETAILED DESCRIPTION

This document describes systems and methods for deriving analytic value through the evaluation of population-based behaviors leveraging customer archetypes. For example, when presented with a transaction(s) indicative of vacation travel for a customer for whom vacation travel transactions have not been seen in the past, it can be asked what a typical customer is likely to do when on vacation in a tourist location. What types of transactions or locations are highly probable or highly improbable for the customer based on others like him or her?

To properly form the event probability, a novel application of n-grams is utilized by a computer processor to represent events. First, the creation of n-grams and associated probabilities are discussed in the context of computer-implemented analytics of payment card fraud, which naturally extends to online banking, retail banking, and mobile banking After discussing n-grams and the associated probability creation, the appropriate customer segmentation to properly group customers to create probability measures for the events is described.

N-Grams

In accordance with implementations described herein, an n-gram is a contiguous sequence of n words from a sequence of language—spoken, text (computer-implemented character-based text, for example), or otherwise. The n-grams are pooled from a collection of documents, known as a corpus, in order to compose a probabilistic model of language sequencing.

In an n-gram text-based probability model, n-grams are generated by examining the first n consecutive words of a sentence (forming the first n-gram), and then, in a step-wise function, continually shifting the examination window by one word. The procedure is repeated until the window covers the last n words of a sentence, paragraph, or other logical linguistic stopping point. In the n-gram model application where n=2 (and, hence, the n-grams are known as bigrams), one generates all the n-grams of a sentence by generating every pair of adjacent words in the sentence. For example, the set of all bigrams from the sentence “All dogs go to heaven.” is “All dogs”, “dogs go”, “go to”, and “to heaven”.

In preferred exemplary implementations, n-grams are applied to data, such as transaction data, that follows a structured, ordered sequence, and to its modeling techniques, where an n-gram is a contiguous sequence of n events from the ordered sequence. In the realm of financial payment transaction data, in some applications an n-gram can be a sequence of contiguous transactions or events for a specific consumer or payment instrument over some event window. Whereas the n-grams in natural language processing applications are composed of n words, the n-grams for financial payment transaction data may be composed of n events such as merchants or merchant categories where purchases are occurring, and can include dollar amounts of spend. These events can conceptually be construed as “words” in which the word itself is a concatenated string composed of multiple transaction characteristics.

In some implementations, a system and method uses and relies on a “big data” data repository, such as FICO's consortium of payment transaction data. From such a big data resource, granular n-gram tables can be generated for specific transaction sequence features, which in turn can be used to inform a streaming analytic model, enriching the fraud score. Because of this wealth of data, the n-gram “words” for payment transaction data can robustly encompass many transactional traits: in some implementations this may mean creating n-gram “words” formed of concatenated information pertaining to the merchant category code, point-of-service entry mode, transaction amount, and transaction location, among many more eligible data characteristics.

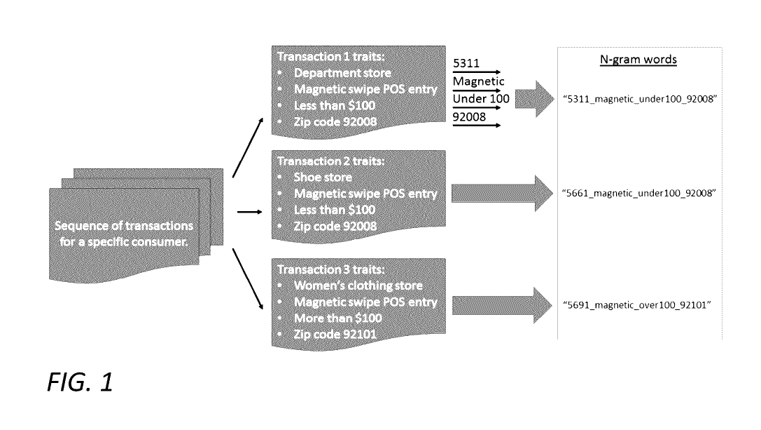

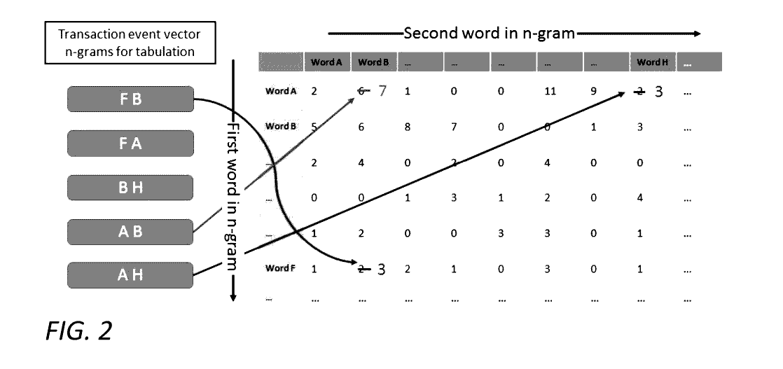

FIG. 1 illustrates a system and method for generating n-gram “words” on a sequence of transactions for one consumer. By way of example, FIG. 2 illustrates how generated “words” may then form an n-gram probability model by tabulating the occurrence of each n-gram on some set of data, which then returns the historically-calculated conditional probability for the new n-gram being modeled/scored. In one implementation of an n=2 (bigram) text prediction probability model, where the model is attempting to predict the next word the user will input, the model will use the most recently typed word as a key to the historical tabulation and will predict the most common words that follow the most recently typed word. The output, the most common words that follow the key, may be presented to the predictive text user as a single press option, giving the user a shortcut to composing the sentence. In financial payment transaction fraud implementations, tabulated probabilities are used as a supplemental probability of occurrence, which can be expressed as a score or used in a set of n-gram features over time to enrich a fraud score with the likelihood of the event sequence based on similar customers. Low historical n-gram occurrence may be indicative of fraud, while high historical n-gram occurrence may be indicative of non-fraud and normal behavior across many customers in a peer group.

Transaction Event Vectors

A further consideration for financial payment transaction n-gram generation is the concept of transaction event vectors. In text analytics, logical and natural stopping points for generating n-grams exist; sentence punctuation, newline characters, and other linguistic segmentation markers inform the n-gram generator to cease the construction of n-grams. One should not treat words that occur on opposite sides of a period, for example, the same way as one treats adjacent words in the middle of a sentence. Generally, words on opposite sides of punctuation marks are less related to one another, predictably, than adjacent words. In these natural language processing applications of n-grams, the units that subsist after the document has been logically split into iterate-able segments (like sentences and paragraphs) is what one may consider to be the event vectors of the document. N-grams may only be generated within the event vectors.

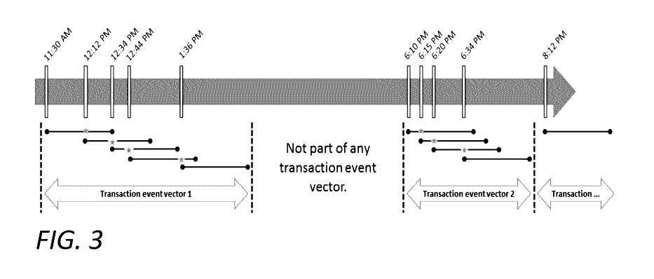

In financial payment transactions n-gram generation, there is no naturally occurring segmentation “punctuation” for splitting a transaction sequence into event vectors (which are then suitable for n-gram generation). However, the absence of transactions over some time period is suitable “punctuation” for financial payment transaction sequences. Like words on opposite sides of textual punctuation, in some implementations transactions on opposite sides of consumer inactivity are less related to one another, predictably, than transaction “words” that occur in quick succession, as illustrated in FIG. 3.

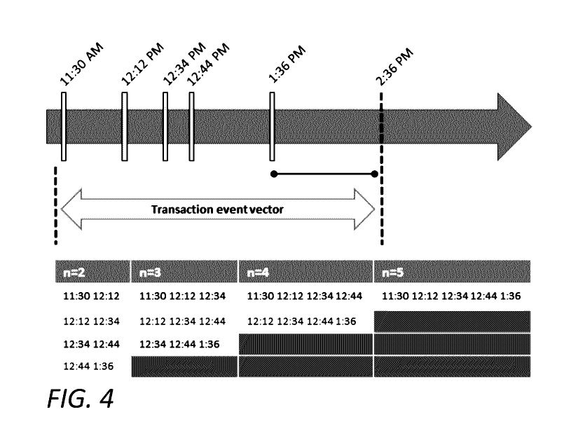

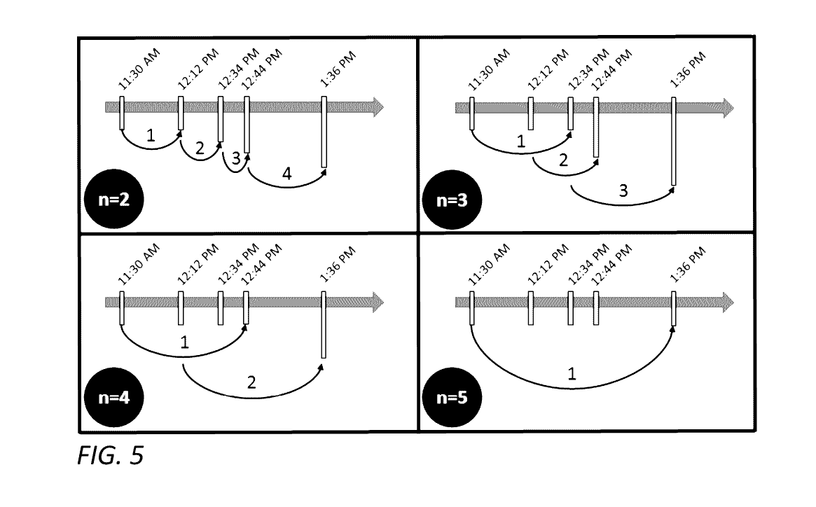

In these financial payment transaction applications of n-grams, the transaction sequence units that subsist after the consumer history has been logically split into iterate-able segments are considered the transaction event vectors for the consumer. FIGS. 4 and 5 illustrate N-grams being generated within these transaction event vectors. It should be noted that different transactions may have different event time-scales; for example, it often takes longer to make purchases at a clothes or grocery store than it does at a coffee shop at the mall. When it comes to distance measures in the word definitions, likewise the ‘punctuation’ between words becomes a function of typical times for a transaction and transit between locations.

When forming the consumer transaction history “punctuation”, transaction event vectors are generated that capture differentiable and novel temporal traits. In accordance with implementations described herein, there are at least two principle temporal traits that play an important role in the manifestation of predictively high and low probabilities for a specific sequence of purchase transactions: purchase duration and continuation likelihood(s).

Purchase duration describes the amount of time necessary to complete a specific transaction. Some transactions take longer to complete than others based on the fundamental characteristics that comprise how that purchase is executed. For example, a high-dollar card-present merchandise transaction at a grocery store or supermarket takes significant time to complete; one does not arrive at a supermarket to find a grocery cart full of every item he/she was going to purchase. N-grams, or the mechanism upon which the n-grams are leveraged, benefit from the inclusion of these dynamic time ranges to capture the fundamental purchase duration associated with each specific transaction. It is important to note that purchase duration is not limited to the discussion of transactions which take a long or short time leading up to the use of the payment instrument.

Purchase duration describes the entire time sequence related to the specific transaction, which encompasses any time leading up to the payment instrument being used and any time following the payment instrument being used, and for most card-present purchases will include average transit times to locations. In particular, purchase duration also describes transactions which occur very early in the transaction sequence. For example, an initial transaction at a movie theater is very unlikely to be followed by any other transaction for several hours (i.e. the duration of the film), except other transactions at that same theater location. A transaction occurring shortly after a card-present transaction at a movie theater may be treated as a more suspicious transaction, increasing fraud detection. On the other hand, a high-dollar card-present transaction at a grocery store, preceded by an appropriate purchase duration may be treated as a less suspicious transaction, decreasing false positives.

Continuation likelihood describes how specific transactions influence near-term behavior for a specific payment instrument. Some transactions are more likely to lead—or are indicative of the customer entering a period of increased activity—to a continuous string of purchases. For example, a card-present merchandise transaction at a department store has been found to significantly increase the likelihood of another transaction within the near-future, often in the form of a related “shopping” transaction, like those that occur at clothing stores, shoe stores, or jewelry stores. N-grams, or the mechanism upon which the n-grams are leveraged, benefit from the inclusion of the dynamic continuation likelihood for each specific transaction. As with purchase duration, continuation likelihood is a bi-directional measurement, meaning that going to the grocery store and then dry cleaning may be equivalent to going to the dry cleaning and then grocery store.

Continuation likelihood describes the entire continuation sequence related to the specific transaction, which encompasses any change in purchase likelihood following the specific transactions and the change in purchase likelihood for any transactions which may have preceded the specific transaction. In particular, continuation likelihood also describes transactions whose occurrence signals that the transaction sequence may be complete. For example, a high-dollar card-present merchandise transaction at a grocery store or supermarket is more likely to be preceded by a sequence of transactions over a short time period than to be followed by a sequence of transactions over a short time period while the groceries may be spoiling; one is more likely to visit a fabrics store and a pet supplies store prior to purchasing a large volume of groceries than one is to visit a fabrics store and a pet supplies store while groceries sit in a hot car. A topical transaction occurring shortly after a card-present transaction with a high continuation likelihood may be treated as a less suspicious transaction, decreasing false positives. On the other hand, a card-present transaction occurring shortly after a transaction with a low continuation likelihood may be treated more suspiciously, increasing fraud detection.

In order to capture these dynamic purchase durations and continuation likelihoods, selecting appropriate transaction event vector time ranges is particularly important. One such implementation may use the time between transactions as part of the concatenated string comprising the “word” for the transaction, in essence covering all possible time gaps in one tabulated n-gram table. Another implementation may build separate tabulated n-gram tables for discrete time ranges: for example, building a tabulated bigram table for transactions separated by 0-10 minutes and a separate tabulated bigram table for transactions separate by 10-90 minutes.

Furthermore, n-grams can be constructed to capture cyclical information. In one such implementation, the n-gram tables may be computed separately depending on the day or hour (or other descriptive unit) of week or month (or other descriptive unit). The conditional probabilities associated with many transaction sequences may differ greatly based on cyclical trends. For example, card-not-present transactions may be more likely to be bunched together during hours in which brick-and-mortar stores are not open, whereas shopping and grocery transactions are more likely to be bunched together on a weekend day. One implementation of this type of model may tabulate weekend and weekday transaction event vectors differently from one another. The probability delivered to enrich the fraud score is based on the specific n-gram table for the transaction in question: if the transaction occurs on the weekend, the weekend n-gram tabulated probability is returned. Note, as will be discussed below, forming the correct customer archetypes is also essential as there are differences in spending behaviors as evidence by those that flock to the malls during the holidays, versus those that avoid the malls during the holidays.

In another implementation, the day or hour (or other descriptive unit) of week or month (or other descriptive unit) may be used as a string in part of the concatenated “word” describing the specific event. Transaction sequences can be expected to differ based on hourly behavior. For example, a transaction event vector that begins with a restaurant transaction is more likely to be followed by “words” related to bars, drinking pubs, and clubs if the restaurant transaction occurs at 9:00 PM than if the restaurant transaction occurs at 7:00 AM. Given enough data, by using an hour as part of the “word” string, the tabulated n-gram table will not have these two different behavioral event vectors belonging to the same key in the same table; instead, separate 7:00 AM restaurant and 9:00 PM restaurant keys will exist in the table, returning different conditional probabilities for subsequent transactions.

Archetype-Based N-Gram Probabilities

As has been emphasized, what is typical in terms of transaction event streams for one set of customers could be very different for other customers, and can vary based on working hours, socio-economic status, age, etc. Therefore, it is important to understand what is typical for a particular class of consumer, i.e. for a college student vs. working family vs. retired individual, for example, when assigning probabilities to event streams.

The different behaviors of customers are most easily learned rather than assigned, and there exist a number of methods to learn archetypes of customer behaviors. This is actually superior to using KYC (Know Your Customer) methods, where certain individuals don't fit age/demographic stereotypes. In some exemplary implementations, a soft clustering approach based on actual transaction streams of the customer is used to assign the relevant archetypes.

Collaborative filtering techniques can also be used to determine ‘archetypes’ of streams of purchase transactions associated with a payment card. Often this is done in the form of Merchant Category Codes (MCCs) coupled with purchase amounts. In these implementations, documents of MCC strings characterize the transaction purchase history. As an example, an MCC document of ‘grocery, dry cleaning, utility, grocery, day care’ will have a different archetype loading than a MCC document of ‘fast food, bar, liquor store, bar, fast food’. Collaborative filtering can be used to objectively create archetype of customers that adjust based on the purchase transaction history for the customer over time.

Although MCC documents may appear individualized, there are some certain regularities of classes of users' MCC transaction history that can be learned when viewing customers in totality. To find these common archetypes, the high dimensional space of streams of MCC documents are used and models are built that reduce the dimensionality into an ‘archetype’ space, which encompasses collective behaviors typically seen in a customer's purchases. In some preferred implementations, the observed data is modeled with a statistical “topic model,” a set of techniques originally developed for, but not restricted to, document classification.

In particular, in some preferred implementations, a Latent Dirichlet Allocation (LDA) model is used, which is a Bayesian probabilistic method that simultaneously estimates probability distributions over archetypes (topics) to each of the profiled customers, and a probability distribution of MCCs and derived profile variables for each topic. The latter, in the form of a matrix for a LDA model, is called the “model” and represents collective behaviors relating to observed MCC and derived profile variables to discovered archetypes. The number of archetypes is usually substantially lower than the cardinality of the word space so it can be considered a dimensionality reduction method.

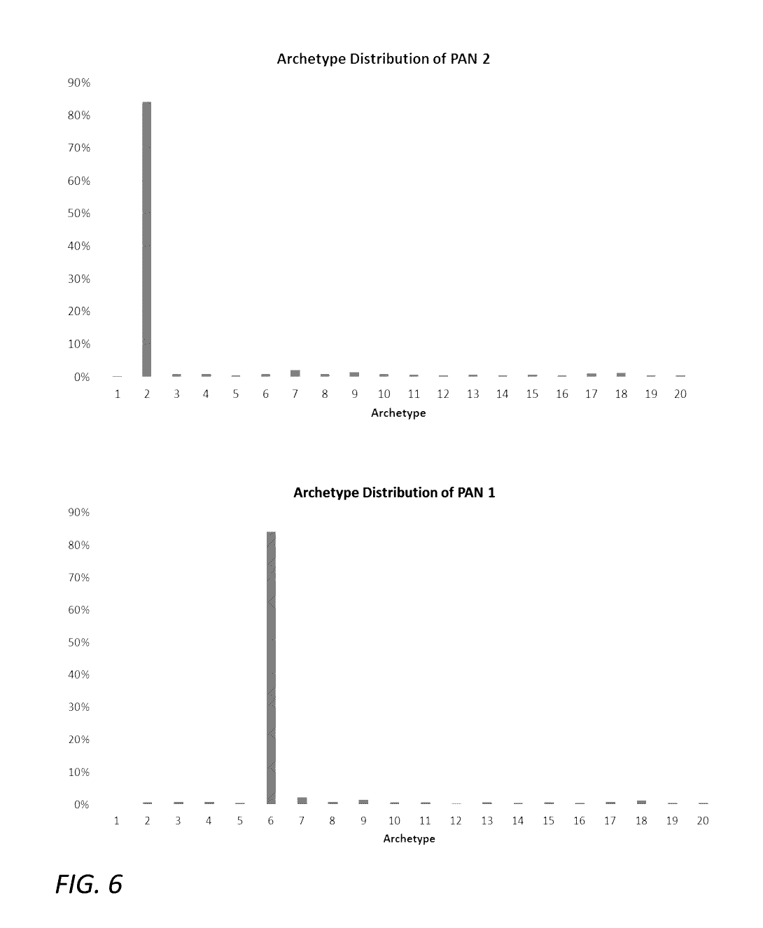

These archetypes have shown to be strongly interpretable, and further that most customers will align very strongly with one archetype. This allows a trivial method of deriving a classification of customers based on their archetype association. Further, then the probabilities associated with n-grams are based on peer grouping, in turn based on the dominant archetype associated with each customer. Other methods such as K-means can be used for edge cases of classifying cards that are not strongly dominated in one archetype, but, in practice, nearly all cards are dominated by one archetype, or a larger topic space is used to allow for more archetypes, as illustrated in FIG. 6.

When using the LDA model by the computing system in scoring mode, the archetype loadings are updated in real-time within the transaction profile of the user/device. Methods to accomplish this are described in U.S. patent application Ser. No. 14/566,545, entitled “Collaborative Profile-Based Detection of Behavioral Anomalies and Change-Points,” the contents of which are incorporated herein by reference for all purposes. These methods relate to analytical techniques to allow for profiling MCC and derived profile variables and utilizing real-time collaborative profiling to determine archetypes based on purchase data, and discuss a method for recursively updating the archetypes in a customer's transaction profile as data streams into a scoring model. Utilizing these techniques allows a set of real-time profile-based MCC and derived profile variable ‘archetypes’ to be continually maintained/refined as real-time purchase transactions occur for a customer.

N-Gram Probability and Derived Features

Once the correct customer segmentation is determined through dominant archetype loadings for a payment card, then the statistics are based on transactions belonging to customers in different archetypes. While the conditional probability is one implementation that may enrich the fraud model on its own, there exist multiple enhanced methods for using tabulated n-gram tables to enrich the fraud model: creating relative probabilities, simulating Markov-chain sequence likelihood measurements, or deriving variables from the n-gram probabilities to be used as input(s) to more complicated models.

When leveraging the statistics within the archetype, simple probabilities can be determined, such as

$$P ( A , B ) = \frac{\# ( A , B )}{N} ,$$

where #(A,B) represents the number of occurrences of the 2-gram (A,B) divided by the total of all 2-grams in the data for the archetype. This gives a relative probability of the commonality of two purchase MCCs to be collocated in a transaction stream. In the bi-directional case, the probabilities can be examined as follows:

$$P ( ( A , B ) , ( B , A ) ) = \frac{\# ( A , B ) + \# ( B , A )}{N}$$

Both of these are simple measures of the occurrence of 2-grams in the data of the archetype. Such statistics could extent to n-grams of sizes greater than 2. When looking at the occurrence of, say, the 2-gram (A,B), the question exists as to whether the preceding occurrence of A is relevant. In other words, is (A,B) common for card holders only because B is universally probable? To determine this, conditional probabilities are used:

$$P ( B \vert A ) = \frac{P ( A , B )}{P ( A )}$$

The ratio above measures the extent P(A,B) may be probable due to A being generally likely. For illustrative purposes lets assign meaning to A,B where ‘A’ is a gas station transaction and B is a grocery transaction and our data is of the form:

(A,B), (A,A), (B,A), (A,C), (A,D), (A,B), (A,L), (A,B), (A,B), (C,B)

In one example, P(B|A)=0.4/0.5=0.8 (grocery following gas) vs. P(A|A)=0.1/0.5=0.2 (gas following gas). This would emphasize that although gas transactions are generally likely—50% of all transactions in the sequences above, since repeated gas transactions are more unlikely.

These concepts can be applied to longer strings of n-grams, or a transaction string of the last X transactions can be monitored to track the probability using these conditional probabilities to build the probability of the entire string of transactions. One can derive a fraud score based just on the sequence probabilities as a stand-alone fraud score. Another preferred approach is to utilize likely sets of purchase events vs. unlikely groups of events in these strings in the streaming fraud behavioral analytics model. As an example, if a card is in a suspected fraud scenario based on behavioral analytics and transaction sequences are seen that are highly improbable in the context of similar archetyped customers, that would re-inforce a determination of fraud. On the contrary, if the fraud profile appears risky but the transaction sequence is highly probable, it reinforces the likeliness of the transaction sequences and will reduce a potential determination of fraudulent activity. Words that form the transaction sequences can include concatenation of MCC with dollar amounts or postal codes to provide insight into likely events in an event stream for a customer.

In some implementations, a system and method are provided in which an entire sequence of transactions—a transaction event vector—may be evaluated on the whole. One such implementation may be calculated by a Monte Carlo Markov Chain process. For example, if the transaction event vector is comprised of seven transactions, the entire transaction sequence may be evaluated as the combined conditional multiplicative probability of the six constituent bigram conditional probabilities from the n-gram table (or five trigrams, four n=4 grams, and so on, depending on how the n-gram tables were tabulated).

Combining N-Gram Probabilities in a Score.

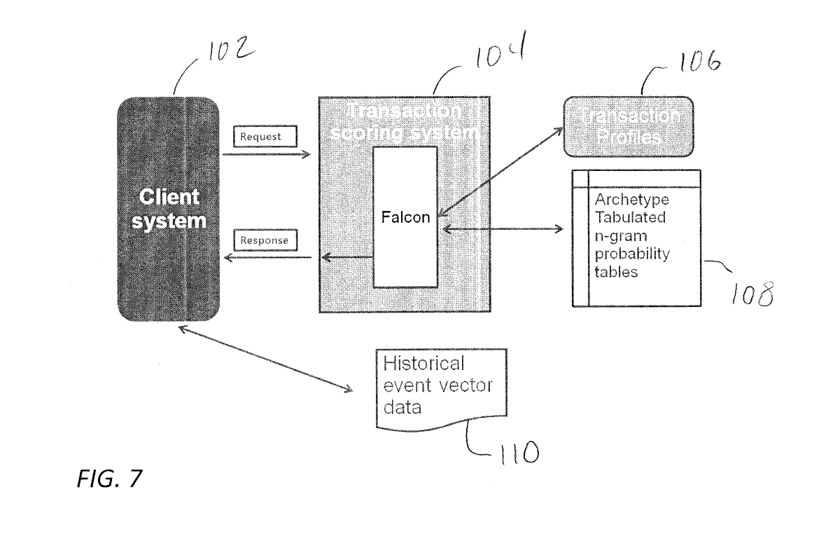

The fraud models of a conventional system, like FICO's Falcon Fraud Manager, utilize a card profile generally indexed by the payment instrument's Primary Account Number (PAN). A card profile, which is a set of recursive variables updated in real-time, summarizes fraud features associated with behavioral analytics. Given that it is preferable to bring in the probabilities of event sequences based on the archetype classifications of a broad population, one way this can be accomplished is to bring the variables directly into the Falcon model variable set to supplement the behavioral score with the likelihood of the transaction sequence based on such a population (a bank's portfolio of cardholders, or based upon a consortium of banks collaborating to fight fraud). In addition to the instantaneous probability of the current sequence, the average of event sequence probabilities can be tracked over time to determine how the current sequence probability compares to a history of peer transaction sequences in the specifics of event ordering, size of transactions, and transaction event vectors 110 shown in FIG. 7. These variables can then be used directly in a neural network, as illustrated in FIG. 7.

FIG. 7 illustrates an architecture 100 for an archetype-driven n-gram probability enhanced fraud detection model. As a transaction occurs, such as a use of a credit card for example, a client system 102 sends a scoring request to a transaction scoring system 104. The transaction scoring system 104 retrieves the transaction profiles 106 for the card and extracts the archetype indexed peer-group n-gram probability tables 108. The behavioral profile and archetype based n-gram variables are utilized in the neural network score creation. The score is returned to the client system 102 and used for detection and decisioning.

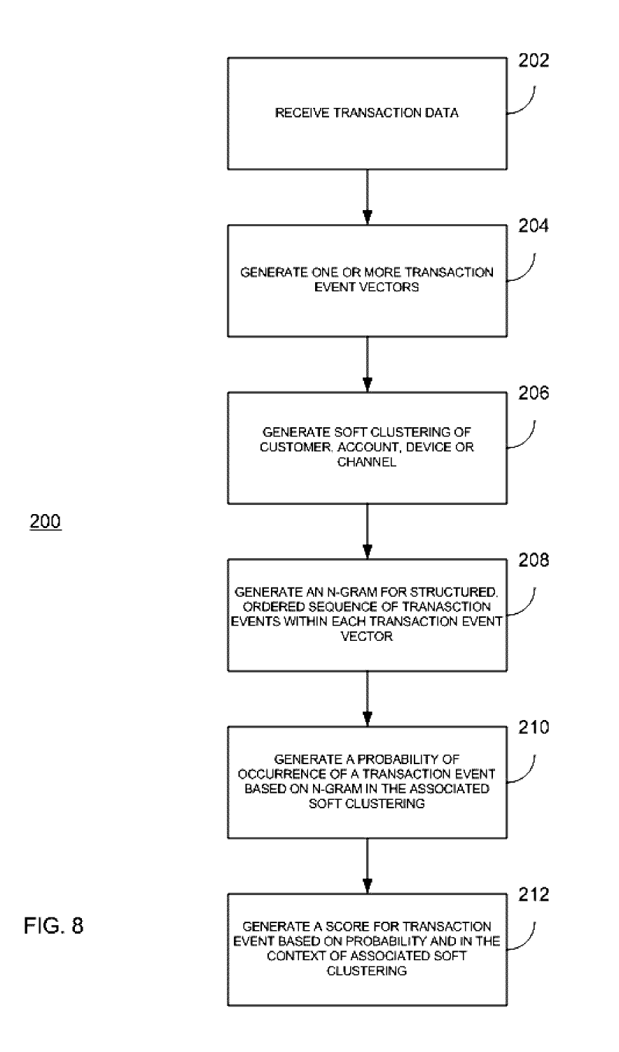

FIG. 8 is a flowchart illustrating a method 200 in accordance with implementations described herein. At 202 transaction data of a structured, ordered sequence of transaction events is received. The transaction data of each transaction event is made up of a concatenated string composed of one or more transaction characteristics. At 204, one or more transaction event vectors is generated from the transaction data, each of the one or more transaction event vectors representing a unique temporal trait associated with the one or more transaction characteristics. At 206, a soft clustering of customer, account, device, or channel is generated, based on archetypes derived from a transaction history associated with the customer, account, device, or channel.

At 208, an n-gram is generated for the structured, ordered sequence of transaction events within each of the one or more transaction event vectors, each n-gram representing an historical occurrence of each transaction event within an associated transaction event vector. At 210, a probability of an occurrence of a transaction event is generated or calculated based on the n-gram within the associated transaction event vector and associated with the soft clustering of the customer, account, device, or channel. At 212, a score is generated for the transaction event, the score representing the probability of the occurrence of the transaction event in the context of the associated soft clustering of the customer, account, device, or channel. Method 200 can be executed by a computer processor as a standalone process, or as an enhancement to a transaction score from a transaction scoring system.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving, by one or more data processors, transaction data of a structured, ordered sequence of transaction events, the transaction data of each transaction event comprising a concatenated string composed of one or more transaction characteristics;
generating, by the one or more processors, one or more transaction event vectors from the transaction data, each of the one or more transaction event vectors representing a unique temporal trait associated with the one or more transaction characteristics;
generating, by the one or more processors, a soft clustering of customer, account, device, or channel based on archetypes derived from a transaction history associated with the customer, account, device, or channel;
generating, by the one or more data processors, an n-gram for the structured, ordered sequence of transaction events within each of the one or more transaction event vectors, each n-gram representing an historical occurrence of each transaction event within an associated transaction event vector;
generating, by the one or more data processors, a probability of an occurrence of a transaction event based on the n-gram within the associated transaction event vector and associated with the soft clustering of the customer, account, device, or channel; and
generating, by the one or more data processors, a score for the transaction event, the score representing the probability of the occurrence of the transaction event in the context of the associated soft clustering of the customer, account, device, or channel.

2. The method in accordance with claim 1, wherein the unique temporal trait associated with the one or more transaction characteristics is purchase duration of a purchase event.

3. The method in accordance with claim 1, wherein the unique temporal trait associated with the one or more transaction characteristics is continuation likelihood of a purchase event.

4. The method in accordance with claim 1, wherein at least one n-gram represents a financial payment transaction.

5. The method in accordance with claim 4, wherein the transaction data of the structured, ordered sequence of transaction events includes one or more merchants.

6. The method in accordance with claim 4, wherein the transaction data of the structured, ordered sequence of transaction events includes one or more merchant categories.

7. The method in accordance with claim 4, wherein the transaction data of the structured, ordered sequence of transaction events includes an amount spent by a consumer.

8. A system comprising:
at least one programmable processor; and
a machine-readable medium storing instructions that, when executed by the at least one processor, cause the at least one programmable processor to perform operations comprising:
receive transaction data of a structured, ordered sequence of transaction events, the transaction data of each transaction event comprising a concatenated string composed of one or more transaction characteristics;
generate one or more transaction event vectors from the transaction data, each of the one or more transaction event vectors representing a unique temporal trait associated with the one or more transaction characteristics;
generate a soft clustering of customer, account, device, or channel based on archetypes derived from a transaction history associated with the customer, account, device, or channel;
generate an n-gram for the structured, ordered sequence of transaction events within each of the one or more transaction event vectors, each n-gram representing an historical occurrence of each transaction event within an associated transaction event vector;
generate a probability of an occurrence of a transaction event based on the n-gram within the associated transaction event vector and associated with the soft clustering of the customer, account, device, or channel; and
generate a score for the transaction event, the score representing the probability of the occurrence of the transaction event in the context of the associated soft clustering of the customer, account, device, or channel.

9. The system in accordance with claim 8, wherein the unique temporal trait associated with the one or more transaction characteristics is purchase duration of a purchase event.

10. The system in accordance with claim 8, wherein the unique temporal trait associated with the one or more transaction characteristics is continuation likelihood of a purchase event.

11. The system in accordance with claim 8, wherein at least one n-gram represents a financial payment transaction.

12. The system in accordance with claim 11, wherein the transaction data of the structured, ordered sequence of transaction events includes one or more merchants.

13. The system in accordance with claim 11, wherein the transaction data of the structured, ordered sequence of transaction events includes one or more merchant categories.

14. The system in accordance with claim 11, wherein the transaction data of the structured, ordered sequence of transaction events includes an amount spent by a consumer.

15. A method comprising:
generating, by one or more data processors, real-time transaction profiles with recursive fraud features to generate one or more fraud models, each of the one or more fraud models providing a fraud likelihood, the real-time transaction profiles including past transaction behavior of each of one or more customers;
training, by one or more data processors, the one or more fraud models for a degree of normality or abnormality based on the real-time and past transaction behaviors of the one or more customers;
determining, by one or more data processors, the degree of normality or abnormality of real-time transactions according to the real-time transaction profiles and trained fraud models to generate a fraud score representing the fraud likelihood;
enhancing, by one or more data processors, the fraud score using archetype-based n-grams based on an event sequence of the real-time transactions, the n-grams providing an additional set of recursive fraud features representing a probability based on a specific sequence of behavioral events and their likelihood, in which high probability n-grams represent typical behaviors of customers in a same peer group, and low probability n-grams represent rare event sequences and increased risk of fraud; and
generating, by one or more data processors, an enhanced fraud score according to the archetype-based n-grams.

16. The method in accordance with claim 15, wherein each of the archetype-based n-grams comprises:
receiving, by one or more data processors, transaction data of a structured, ordered sequence of transaction events, the transaction data of each transaction event comprising a concatenated string composed of one or more transaction characteristics;
generating, by one or more processors, one or more transaction event vectors from the transaction data, each of the one or more transaction event vectors representing a unique temporal trait associated with the one or more transaction characteristics;
generating, by one or more processors, a soft clustering of customer, account, device, or channel based on archetypes derived from a transaction history associated with the customer, account, device, or channel;
generating, by one or more data processors, an n-gram for the structured, ordered sequence of transaction events within each of the one or more transaction event vectors, each n-gram representing an historical occurrence of each transaction event within an associated transaction event vector;
generating, by one or more data processors, a probability of an occurrence of a transaction event based on the n-gram within the associated transaction event vector and associated with the soft clustering of the customer, account, device, or channel; and
generating, by one or more data processors, a score for the transaction event, the score representing the probability of the occurrence of the transaction event in the context of the associated soft clustering of the customer, account, device, or channel.

17. The method in accordance with claim 16, wherein at least one n-gram represents a financial payment transaction.

18. The method in accordance with claim 16, wherein the transaction data of the structured, ordered sequence of transaction events includes one or more merchants.

19. The method in accordance with claim 16, wherein the transaction data of the structured, ordered sequence of transaction events includes one or more merchant categories.

20. The method in accordance with claim 16, wherein the transaction data of the structured, ordered sequence of transaction events includes an amount spent by a consumer.
